(19) United States
(12) Patent Application Publication
(10) Pub. No.: US 2017/0015588 A1
(43) Pub. Date: Jan. 19, 2017

(54) HIGH TEMPERATURE AND HIGH PRESSURE CEMENT RETARDER COMPOSITION AND USE THEREOF

(71) Applicant: HERCULES INCORPORATED, Wilmington, DE (US)

(72) Inventors: Mohand MELBOUCI, Wilmington, DE (US); Janice Jianzhao WANG, Hockessin, DE (US)

(73) Assignee: HERCULES INCORPORATED, Wilmington, DE (US)

(21) Appl. No.: 15/211,394

(22) Filed: Jul. 15, 2016

Related U.S. Application Data
(60) Provisional application No. 62/193,847, filed on Jul. 17, 2015.

(51) Int. Cl. C04B 24/26; C08F 216/14; C09K 8/467; C04B 28/04

(52) U.S. Cl. CPC C04B 24/2694; C04B 28/04; C08F 216/1416; C09K 8/467; C04B 2103/20

(57) ABSTRACT

The presently disclosed and/or claimed inventive process concept(s) relates generally to a water soluble or water dispersible composition comprising a copolymer and use in oil field. More particularly, the presently disclosed and/or claimed inventive concept(s) relates to the copolymers comprising allyloxy linkage and its function derivatives and its use in oil field such as a high temperature cement retarder composition.

### CROSS REFERENCE TO RELATED APPLICATIONS

The present application claims the benefit under 35 U.S.C. 119 (e) of U.S. Provisional Patent Application Ser. No. 62/193,847, filed on Jul. 17, 2015, the entire content of which is hereby expressly incorporated herein by reference.

### BACKGROUND

1. Field of the Invention

The presently disclosed and/or claimed inventive process(es), procedure(s), method(s), product(s), result(s), and/or concept(s) (collectively referred to hereinafter as the “presently disclosed and/or claimed inventive concept(s)”) relates generally to a water soluble or water dispersible composition comprising a copolymer and use in gas/oil fields. More particularly, but not by way of limitation, the presently disclosed and/or claimed inventive concept(s) relates to a copolymer comprising an allyloxy linkage and its function derivatives, and use in gas/oil fields such as a high temperature and high pressure cement retarder composition.

2. Background of the Invention

Polymers are used extensively in gas/oil field applications as additives for drilling, cementing, gas and oil well fracturing and enhanced oil-recovery processes. Synthetic, organic, and inorganic polymers, cellulose ethers, guar gum and guar derivatives, and other biopolymers such as xanthan gum, diutan gum and welan gum are widely used in the gas/oil field applications. These polymers are also applied in a variety of formation-damage control applications and as dispersing agents.

During construction of oil and gas wells, a rotary drill is typically used to bore through subterranean formations of the earth to form a borehole. As the rotary drill bores through the earth, a drilling fluid, also known in the industry as a “mud”, or “drilling mud” is circulated through the borehole. Drilling fluids are usually pumped from the surface through the interior of the drill pipe. By continuously pumping the drilling fluids through the drill pipe, the drilling fluids can be circulated out the bottom of the drill pipe and back up to the well surface through the annular space between the wall of the well bore and the drill pipe. The hydrostatic pressure created by the column of mud in the hole prevents blowouts which would otherwise occur due to the high pressures encountered within the well. The drilling fluid is also used to help lubricate and cool the drill bit and facilitates the removal of cuttings as the borehole is drilled.

Once the well bore has been drilled, casing is lowered into the well bore. A cement slurry is then pumped into the casing and fills into the annulus space between the exterior of the casing and the borehole. The cement slurry is then allowed to set and harden to hold the casing in place. The required compressive strength is dependent on casing and hole diameter. Generally, a compressive strength of 500 psi is sufficient for any combination of hole/casing for a typical gas and oil well.

A primary function of the cementing process is to restrict fluid movement between the subterranean formations and to bond and support the casing. In addition, the cement aids in protecting the casing from corrosion, preventing blowouts by quickly sealing formations, protecting the casing from shock loads in drilling deeper wells, sealing off lost circulation or thief zones and forming a plug in a well to be abandoned.

The cement also provides zonal isolation of the subsurface formations, helps to prevent sloughing or erosion of the well bore and protects the well casing from corrosion from fluids which exist within the well. In this scenario the important factor is the final permeability of the set cement, which is strictly related to the solid content of the slurry and consequently to the compressive strength of the set cement.

Completion of a well refers to the operations performed during the period from drilling-in the pay zone until the time the well is put into production. These operations may include additional drilling-in, placement of downhole hardware, perforation, and control operations, such as gravel packing, and cleaning out downhole debris. A completion fluid is often defined as a wellbore fluid used to facilitate such operations. The completion fluid's primary function is to control the pressure of the formation fluid by virtue of its specific gravity. The type of operation performed, the bottom hole conditions, and the nature of the formation will dictate other properties, such as viscosity. Use of completion fluids also clean out the drilled borehole. Oil well cement compositions are used in the completion operation to make a permanent, leak proof well for continuous use.

Cement slurries for use in such applications contain hydraulically active cements which set and develop compressive strength due to a hydration reaction. Hydraulically active cements are cements that set and develop compressive strength due to a hydration reaction, and thus can be set under water. As such, hydraulically active cements are often used for cementing pipes or casings within a wellbore of a subterranean formation as well as other purposes, such as squeeze cementing. In cementing operations of gas and oil wells, hydraulically active cement is normally mixed with sufficient water to form a pumpable cement slurry and the slurry is injected into a subterranean zone to be cemented. After placement in the zone, the cement slurry sets into a hard mass.

In primary cementing, where the cement slurry is placed in the annulus between a casing or liner and the adjacent earth formations, fluid loss control is one of the critical concerns, especially at high temperature, high pressure (squeeze cement) and salt environments. Loss of a significant amount of water from the cement slurry can cause changes in several important operation parameters, such as reduced pumping time and increased frictional pressure. In addition, the formations can result in premature gelation of the cement slurry and bridging of the annulus before proper placement of the slurry. In remedial cementing operations, the control of fluid loss is necessary to achieve the more precise cement slurry placement associated with such operations. The main purpose of fluid loss additive is to prevent dehydration of the cement slurry that can reduce its pumpability as well as affecting its other designed properties.

Fluid loss additives are used to help prevent water loss from cement slurry to the rock formation as the slurry is pumped into the annulus between the casing and the well bore. This allows displacing the maximum amount of mud, compressive strength development, and bonding between the formation and the casing. In fact, under harsh conditions and due to permeable zones, the slurry can dehydrate quickly and become unpumpable, preventing the extension of slurry into voids and channels, particularly where the annular space between the liner and the open hole is too narrow. Any bridging problem due to high fluid loss would considerably disturb the cement job and affect the integrity of the cement column.

In a typical completion operation, the cement slurry is pumped down the inside of the pipe or casing and back up the outside of the pipe or casing through the annular space. This seals the subterranean zones in the formation and supports the casing. Under normal conditions, hydraulically active cements, such as Portland cement, quickly develop compressive strength upon introduction to a subterranean formation, typically within 48 hours from introduction. As the time passes, the cement develops greater strength while hydration continues.

Deep gas and oil wells are generally subjected to high temperature gradients that may range from 20° C. at the surface to 260° C. at the bottom of such wells. The geology of the well traversed may also contain environments, such as massive salt formations, that can adversely affect the cementing operation. For example, the high temperatures at the bottom of the wells can lead to problems in effective placement of the cement slurry. The time taken to pump a cement slurry into a deep well can mean that the onset of thickening caused by cement setting can become a problem, potentially leading to setting of the cement before it is properly placed either around the casing or as a plug.

This setting phenomenon has lead to the development of a series of additives for the cement slurry known as ‘retarders’. These additives act on the cement slurry to delay setting for a sufficient period of time to allow the slurry to be properly placed. Such set retarders are particularly useful when the cement composition is exposed to high subterranean temperatures. In addition to being capable of delaying the set time of the cement composition, the set retarder also functions to extend the time the cement composition remains pumpable after the cement composition is mixed and before it is placed into the desired location.

In use, many of the set retarders of the prior art exhibit unpredictable retardation of the set time of the cement composition especially at elevated temperatures. For instance, lignosulphonates or gluconates are often used with borate retarder intensifiers to retard Portland cement in oil wells at temperatures less than 120˜150° C. A need therefore exists for the development of cement compositions containing a set retarder (preferably which does not require an intensifier) and which is effective at downhole temperatures at higher temperature, for example, in excess of 150° C.

### DETAILED DESCRIPTION OF THE INVENTIVE CONCEPT(S)

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those of ordinary skill in the art that variations may be applied to the articles and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope and concept of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” may mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 1, 2, 3, 4, 5, 10, 15, 20, 30, 40, 50, 100, etc. The term “at least one” may extend up to 100 or 1000 or more depending on the term to which it is attached. In addition, the quantities of 100/1000 are not to be considered limiting as lower or higher limits may also produce satisfactory results. In addition, the use of the term “at least one of X, Y, and Z” will be understood to include X alone, Y alone, and Z alone, as well as any combination of X, Y, and Z. The use of ordinal number terminology (i.e., “first”, “second”, “third”, “fourth”, etc.) is solely for the purpose of differentiating between two or more items and, unless explicitly stated otherwise, is not meant to imply any sequence or order or importance to one item over another or any order of addition.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein any reference to “one embodiment” or “an embodiment” means that a particular element, feature, structure, or characteristic described in connection with the embodiment is included in at least one embodiment. The appearance of the phrase “in one embodiment” in various places in the specification are not necessarily all referring to the same embodiment.

The term “copolymer” as used herein will be understood to encompass a polymer produced from two or more different types of monomers. As such, the term “copolymer” may refer to a polymer produced from two different types of monomers, or a polymer produced from three different types of monomers, and/or a polymer produced from four or more different types of monomers.

The presently disclosed and/or claimed inventive concept(s) encompasses a water soluble or dispersible composition comprising a copolymer and use of the composition in gas/oil field. More particularly, but not by way of limitation, the presently disclosed and/or claimed inventive concept(s) relates to a copolymer containing allyloxy linkage and its function derivatives for use in gas/oil field such as a high temperature cement retarder composition.

In one aspect, a water soluble or dispersible composition of the presently disclosed and/or claimed inventive concept(s) comprises a copolymer represented by Formula (I):

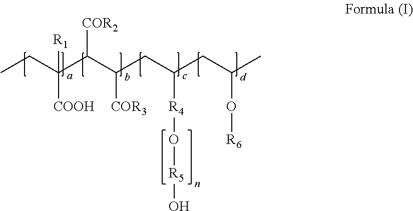

where R₁ is hydrogen, or straight or branched C₁-C₅ alkyl; R₂ and R₃ are independently OH or NH₂; R₄ is C═O, or independently straight or branched C₁-C₅ alkyl; R₅ is independently straight or branched C₁-C₅ alkyl; R₆ is hydrogen or COR₇, wherein R₇ is straight or branched C₁-C₅ alkyl; and n is an integer from 1 to about 100.

In one non-limiting embodiment, the copolymer represented by Formula (I) can be obtained by copolymerizing:

(a) 15 to 75 moles of an alpha, beta ethylenically unsaturated carboxylic acid represented by Formula (II):

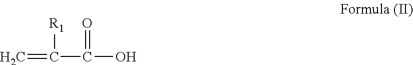

where R₁ is as defined above;

(b) 15 to 75 moles of an unsaturated dicarboxylic acid, or an unsaturated dicarboxylic amide represented by Formula (III):

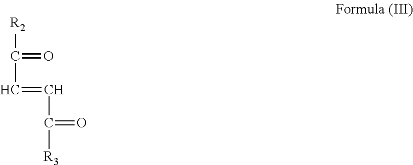

where R₂ and R₃ are as defined above;

(c) 5 to 50 moles of hydroxypolyethoxyl allyl ether (PEGAE) represented by Formula (IV):

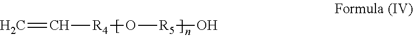

where R₄, R₅ and n are as defined above; and

(d) 5 to 50 moles of vinyl alcohol or vinyl acetate represented by Formula (V):

H₂C═CH—OR₆ Formula (V)

where R₆ is as defined above.

In one non-limiting embodiment, the alpha, beta ethylenically unsaturated carboxylic acid can be acrylic acid. In another non-limiting embodiment, the alpha, beta ethylenically unsaturated carboxylic acid can be an (alk)acrylic acid such as methacrylic acid.

The unsaturated dicarboxylic acid can include, but are not limited to, maleic acid, fumaric acid, and combinations thereof. For hydroxypolyethoxyl allyl ether (PEGAE), n can be in a range of from 1 to about 100, or from about 5 to about 50, or from about 5 to about 20, or from about 8 to about 20. In one non-limiting embodiment, n can be equal to 10.

In another aspect, a water soluble or dispersible composition of the presently disclosed and/or claimed inventive concept(s) comprises a copolymer represented by Formula (VI):

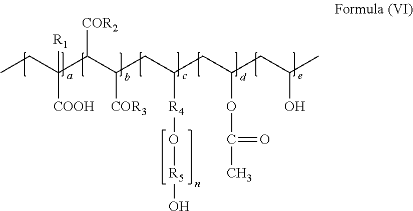

where R₁-R₅ and n are as defined above.

In one non-limiting embodiment, the copolymer represented by Formula (VI) can be obtained by copolymerizing:

(a) 15 to 75 moles of an alpha, beta ethylenically unsaturated carboxylic acid represented by Formula (II);

(b) 15 to 75 moles of an unsaturated dicarboxylic acid, or an unsaturated dicarboxylic amide represented by Formula (III);

(c) 5 to 50 moles of hydroxypolyethoxyl allyl ether (PEGAE) represented by Formula (IV);

(d) 5 to 50 moles of vinyl acetate represented by Formula (V); and

(e) 5 to 50 moles of vinyl alcohol.

The copolymers of the presently disclosed and/or claimed inventive concept(s) may be produced by solution, emulsion, micelle or dispersion polymerization techniques. Conventional polymerization initiators such as persulfates, peroxides, and azo type initiators may be used. In the case of solution polymerization using water as a solvent, a persulfate including sodium persulfate, potassium persulfate, ammonium persulfate or the like; hydrogen peroxide or a water soluble azo initiator may be used. Further, in the case of solution polymerization an organic solvent such as a lower alcohol including methanol, ethanol, isopropanol or the like; an aliphatic hydrocarbon including n-hexane, 2-ethyl hexane, cyclohexane or the like; an aromatic hydrocarbon including toluene and xylene; and acetone, methyl ethyl ketone, ethyl acetate or the like can be used. In the case of bulk polymerization, an organic peroxide such as benzoyl peroxide, di-t-butyl peroxide, t-butyl peroxy isobutyrate or the like; or an azo compound such as azobisisobutyronitrile may be used. Polymerization may also be initiated by radiation or ultraviolet mechanisms.

Chain transfer agents such as thioglycol acid, isopropanol, allyl alcohol, hypophosphites, amines or mercapto compounds such as mercapto ethanol may be used to regulate the molecular weight of the copolymer. Branching agents, such as methylene bisacrylamide and polyethylene glycol diacrylate, and other multifunctional crosslinking agents may further be added. The resulting copolymer may be isolated by precipitation or other well-known techniques. The polymer can be used as a solid. If polymerization is in an aqueous solution, the copolymer may simply be used in the aqueous solution form.

The weight average molecular weight of the copolymer can be varied from about 1,000 to about 1,000,000 Daltons, or from about 1,500 to about 500,000 Daltons, or from about 2,000 to about 250,000 Daltons, or from about 5,000 to about 150,000 Daltons, or from about 10,000 to about 50,000 Daltons.

The polymerization can be conducted from about 40° C. to about 150° C., or from about 60° C. to about 100° C., or from about 60° C. to about 80° C. under nitrogen purge.

The initiator can be used in a proportion of from about 0.05 to about 20 wt %, or from about 0.01 to about 10 wt %, or from about 0.1 to about 2 wt %, based on the total weight of the sum of the monomers. The initiator can be added to the reaction vessel in various ways during the polymerization. It can all be placed in the reaction vessel or during the polymerization reaction, continuously or stepwise, as it is consumed.

The presently disclosed and/or claimed inventive concept(s) also relates to a high temperature and high pressure cement retarder composition comprising the copolymers as described above.

The cement retarder composition can be used with an aqueous cement slurry for introduction into a gas and/or oil wellbore. The presently disclosed and/or claimed inventive concept(s) relates to a cement slurry comprising the cement retarder composition as described above, a hydraulically-active cement material and water.

The cement retarder composition is capable of delaying the set time of the cement slurry until the slurry is placed into its desired location. When used, the set time of the aqueous cement slurry may be delayed until the downhole temperatures as high as 260° C., or as high as 315° C. are obtained. Thus, the cement slurry may be hardened to a solid mass at elevated temperatures within the wellbore. Further, the cement slurries used in the presently disclosed and/or claimed inventive concept(s) may exhibit set times at elevated temperatures and pressures even in the absence of an intensifier.

The hydraulically-active cement materials, suitable for use in the cement slurry, include materials with hydraulic properties, such as hydraulic cement, slag and blends of hydraulic cement and slag (slagment), which are well known in the art. As used herein, the term “hydraulically-active” refers to properties of a cement material that allow the material to set in a manner like hydraulic cement, either with or without additional activation. The term “hydraulic cement” refers to any inorganic cement that hardens or sets due to hydration.

The hydraulically-active cement materials may also include extenders such as bentonite and gilsonite. The cement materials can be used either without any appreciable sand or aggregate material or admixed with a granular filling material such as sand, ground limestone, and the like. Strength enhancers such as silica powder or silica flour, meta-kaolin, silica fume can be employed as well. The hydraulically-active cement materials can include, but are not limited to, Portland cements (e.g., ISO/API class G or H), sulfur cements, aluminous cements, pozzolan cements, fly ash cements, and the like. In addition, the cement material may comprise weighting agents such as hematite or barite.

The water may be fresh water or salt water, e.g., an unsaturated aqueous salt solution or a saturated aqueous salt solution such as brine or seawater. The water may be present in an amount from about 20 wt % to about 180 wt %, or from about 30 wt % to about 150 wt %, or from about 30 wt % to about 90 wt %, or from about 30 wt % to about 60 wt %, by weight of cement. The amount of water may depend on the desired density of the cement slurry and the desired slurry rheology and as such may be determined by one of ordinary skill in the art with the aid of this disclosure.

Additives can be included in the cement slurry for improving or changing the properties thereof. Examples of such additives can include, but are not limited to, defoaming agents, foaming surfactants, fluid loss additives (FLAs), gas migration control additives, mechanic strength enhancers, antisettling agents, latex emulsions, dispersants, hollow glass, ceramic beads, or combinations thereof. Other mechanical property modifying additives, for example, but not by way of limitation, elastomers, carbon fibers, glass fibers, metal fibers, minerals fibers, and the like can be added to further modify the mechanical properties. These additives may be included singularly or in combination. Methods for introducing these additives and their effective amounts are known to one of ordinary skill in the art with the aid of this disclosure.

Suitable FLA of the presently disclosed and/or claimed inventive concept(s) can include, but are not limited to, XxtraDua™ FLA 3766 and XxtraDua™ FLA 3767 (available from Ashland Inc.); Polytrol® FL34 and Alcomer® 244 (available from BASF); FL-14, FL-17, FL-24 (available from Fritz Industries); Halad® 344 (available from Halliburton); SELVOL™ polyvinyl alcohol (available from Sekisui Specialty Chemicals); carboxymethyl cellulose; carboxy methyl hydroxy ethyl cellulose; xanthan gum; starch; methyl hydroxy ethyl cellulose; propyl hydroxyethyl cellulose; hydroxy ethyl cellulose; guar gum; hydroxy propyl guar; carboxy methyl hydroxy propyl guar, hydroxy ethyl guar; polyvinyl pyrrolidone; and mixtures thereof.

The FLA described herein typically has a weight average molecular weight (MW) over about 3,000 Daltons, or over about 10,000 Daltons, or over about 100,000 Daltons. In one non-limiting embodiment, the weight average molecular weight is in a range of from about 5,000 to about 5,000,000 Daltons. In another non-limiting embodiment, the weight average molecular weight is in a range of from about 10,000 to about 500,000 Daltons. In yet another non-limiting embodiment, the weight average molecular weight is in a range of from about 50,000 to about 400,000 Daltons. The weight average molecular weight can be determined by GPC techniques that are know in the art.

The FLA in the presently disclosed and/or claimed inventive concept(s) can be used in either solid or liquid forms. The liquid form can include a liquid FLA and FLA solution. The required amount of FLA in liquid form for the desired composition of the presently disclosed and/or claimed inventive concept(s) can be in a range of from about 0.01 gps (gallons per sack of cement) to about 10 gps, or about 0.1 gps to about 5 gps, or about 0.5 gps to about 1.5 gps. The required amount of FLA in solid form for the desired composition of the presently disclosed and/or claimed inventive concept(s) can be in a range of from about 0.01% to about 10% BWOC (by weight of the cement), or from about 0.1% to about 5.0% BWOC, or from about 0.2 to about 2.0% BWOC.

Defoaming agents (defoamers) have been used in the oil and gas industries to prevent or reduce the formation of foam or the entrainment of gas in well treatment fluids such as cement slurries, oil field drilling mud, oil and gas separation processes, and the like. They provide better control over the density of the hardened cement that is formed. They have also been used to destroy or “break” previously formed foam in a fluid. For example, a defoaming agent can be added to a well treatment fluid containing foam to break the foam, allowing the fluid to be disposed of more easily.

The defoaming agent in the present disclosed and/or claimed inventive concept(s) can include, but are not limited to, hydrophobic silica, dodecyl alcohol, tributyl phosphate, aluminum stearate, various glycols such as polypropylene glycol, silicones such as polysiloxane emulsions, and sulfonated hydrocarbons.

Various ingredients described above can be available in solid forms, liquid forms, suspensions or aqueous solutions. Generally, the cement slurry comprising the cement retarder composition can be made by adding the solid ingredients into the ingredients in liquid forms, suspensions or aqueous solutions.

In one non-limiting embodiment, the cement retarder composition in solid form can be mixed with other solid ingredients to form a solid mixture. Separately, sufficient water is mixed with the ingredients in liquid forms to form an aqueous solution. The liquid forms include liquid ingredients and ingredients in solutions. Then the solid mixture is added into the aqueous solution to form a cement slurry. The amounts of the cement retarder composition in the solid mixture can be varied from about 0.1% to about 10% BWOC or from about 0.2% to about 5% BWOC.

In another non-limiting embodiment, sufficient water is added into the cement retarder composition in aqueous solution and other ingredients in liquid forms to form an aqueous solution. The liquid forms include liquid ingredients and ingredients in solutions. The solid ingredients are then added into the aqueous solution to form a cement slurry. The amounts of the cement retarder composition in aqueous solution can be varied from about 0.1 gps to about 10 gps or from 0.2 gps to about 5 gps.

The presently disclosed and/or claimed inventive concept(s) also relates to a method of retarding the set time of the cement slurry described above. The method comprises the steps of: (a) introducing the cement slurry as described above into a wellbore, wherein the amounts of water in the cement slurry can be varied from about 30 to about 150 wt % based on the dry weight of the cement material, and (b) allowing the cement slurry to harden to a solid mass. The amount of the cement retarder composition in the cement slurry is sufficient to retard the set time of the cement slurry until the cement slurry is placed in the desired location within the wellbore. The hardening of the cement slurry can be delayed until the downhole temperature is greater than or equal to 260° C. or 315° C.

A method of cementing pipes or casings in an oil and gas wellbore is included in the presently disclosed and claimed inventive concept(s). The method comprises the steps of: (a) pumping the cement slurry as described above down the inside of the pipes or casings and back up the outside of the pipes or casings through the annulus between the pipes or casings and the wellbore, and (b) delaying the set time of the cement slurry. The amount of the cement retarder composition is sufficient in the cement slurry to retard the set time of the cement slurry.

### EXAMPLES

### Copolymer Preparation

### Example 1

To a 1 L reactor, equipped with a water condenser, temperature controller, N₂ inlet/outlet, and oil batch, was added with 78 g polyethylene glycol allyl ether (Rhodasurf®AAE-10, commercially available from Solvay), 150 g deionized water, and 17.8 g maleic acid to form a homogenous solution. The reactor was then purged with N₂ and the temperature was raised to 75° C. Meanwhile, a monomer solution containing 10 g vinyl acetate, 14 g acrylic acid and 15 g deionized water was prepared. After 30 min purge, the monomer solution and 3.25 g V-50 (2,2′-Azobis(2-methylpropionamidine)dihydrochloride (commercially available from Wako Chemicals USA, Inc) dissolved in 20 g deionized water were fed into the reactor from separate pumps over 180 min. After the feeding, the reactor temperature was raised to 80° C. for additional 2 hrs. The reactor was then cooled down and the solution inside the reactor was discharged into a container. 25 g NaOH solution (50%) was added into the container to neutralize the solution to pH=6-7. The aqueous solution was used directly in the test below.

### Example 2

To a 1 L reactor, equipped with a water condenser, temperature controller, N₂ inlet/outlet, and oil batch, was added with 78 g Rhodasurf®AAE-10, 60 g deionized water, and 17.8 g maleic acid to form a homogenous solution. The reactor was then purged with N₂ and the temperature was raised to 75° C. Meanwhile, a monomer solution containing 10 g vinyl acetate and 14 g acrylic acid was prepared. After 30 min purge, the monomer solution, and 3.25 g V-50 dissolved in 20 g deionized water were fed into the reactor from separate pumps over 180 min. After the feeding, the reactor temperature was raised to 80° C. for additional 2 hrs. The reactor was then cooled down and the solution inside the reactor was discharged into a container. 25 g NaOH solution (50%) was added into the container to neutralize the solution to pH=6-7. The solid sample was then obtained by removing water from the solution and used in the test below.

### Example 3

To a 1 L reactor, equipped with a water condenser, temperature controller, N₂ inlet/outlet, and oil batch, was added with 58.5 g Rhodasurf AAE-10, 50 g deionized water, and 17.8 g maleic acid to form a homogenous solution. The reactor was then purged with N₂ and the temperature was raised to 75° C. Meanwhile, a monomer solution containing 10 g vinyl acetate and 14 g acrylic acid was prepared. After 30 min purge, the monomer solution, and 3.25 g V-50 dissolved in 20 g deionized water were fed into the reactor from separate pumps over 180 min. After the feeding, the reactor temperature was raised to 80° C. for additional 2 hrs. The reactor was then cooled down and the solution inside the reactor was discharged into a container. 25 g NaOH solution (50%) was added into the container to neutralize the solution to pH=6-7. The solid sample was then obtained by removing water from the solution and used in the test below.

### Testing of the Copolymers

Joppa Class H Portland cement, silica flour at a concentration of 35% by weight of cement (BWOC) and other ingredients in solid forms were mixed together to form solid mixtures. Fresh water was added into the ingredients in aqueous solutions. The solid mixtures were then added into the aqueous solutions to form cement slurries. The ingredients of the cement slurries are listed in Table 1. The amounts were in gallons per sack of cement (gps) for the ingredients in aqueous solutions, and wt % for the solid ingredients. The retarder composition in aqueous solution obtained from Example 1, and the solid retarder compositions obtained from Examples 2 and 3 were used for testing. The resultant cement slurries were kept with occasional agitation. The densities of the cement slurries were 15.8, 16.2 and 16.5 pounds per gallon (ppg).

The “thickening time” can be determined by placing a sample of the cement slurry in a consistometer in which a bob is rotated at elevated pressures and temperatures and to measure the torque required to rotate the bob of the consistometer, the time at which the torque increases to 70/100 Bearden units of consistency (70/100 Bc) being defined as the thickening time. It is indicative of the amount of time that the cement slurry remains pumpable at the stated temperature.

The thickening time of the cement slurries were measured using Model 8340 Single Cell HPHT Consistometer (available from Chandler Engineering) and the results are listed in Table 1. The thickening time for breaking the shear pin is also shown in Table 1.

The experimental data illustrate the ability of the cement slurries, when used in accordance with the presently disclosed and/or inventive concept(s), to thicken and exhibit high compressive strengths over extended periods of time. The presence of the copolymers in the cement slurries function to retard the setting of the cement, especially at elevated temperatures, as evidenced by the increased thickening times. The slurries do not require the presence of an intensifier. Further, the amount of copolymer required to demonstrate the desired degree of retardation is low.

From the foregoing, it will be observed that numerous variations and modifications may be effected without departing from the true spirit and scope of the novel concepts of the presently disclosed and/or claimed inventive concept(s).

TABLE 1

| | H Joppa Cement + 35% Silica Flour | | | | | | | | | | | | Thickening Time | | |
|---|---|---|---|---|---|---|---|---|---|---|---|---|---|---|---|
| | | | | | | | De- | Fresh | Den- | | | | | | Shear |
| Slurry | HEC | FLA-L | FLA-P | Example | Example | Example | foamer | Water | sity | BHCT | Ramp | Pressure | 70 Bc | 100 Bc | Pin |
| Sample | wt % | gps | wt % | 2 wt % | 1 gps | 3 wt % | gps | gps | ppg | ° F. | hr:min | psi | hr:m | hr:m | hr:m |
| 1 | 0.6 | 0.323 | | | | | 0.005 | 5.932 | 15.8 | 350 | 1:30 | 1050-14900 | 2:46 | 2:46 | 2:53 |
| 2 | 0.6 | | 1 | | | | 0.005 | 6.140 | 15.8 | 350 | 1:30 | 1050-14900 | 2:35 | 2:35 | 2:36 |
| 3 | 0.5 | 0.17 | | | 0.17 | | 0.005 | 5.847 | 15.8 | 350 | 0:50 | 1000-11100 | 14:35 | 14:36 | 14:45 |
| 4 | 0.5 | | 0.5 | 0.5 | | | 0.005 | 6.065 | 15.8 | 350 | 1:50 | 1000-11101 | 16:26 | 16:27 | 16:39 |
| 5 | | | 0.5 | 0.5 | | | 0.01 | 5.507 | 16.2 | 300 | 1:14 | 900-11100 | 45:34 | 45:36 | 45:38 |
| 6 | | | 0.5 | 0.5 | | | 0.01 | 5.507 | 16.2 | 350 | 1:22 | 1000-13000 | 13:52 | 13:53 | 13:54 |
| 7 | | | 0.5 | 0.5 | | | 0.01 | 5.112 | 16.5 | 350 | 1:22 | 1000-13000 | 14:06 | 14:06 | 14:11 |
| 8 | | | 0.5 | 0.5 | | | 0.01 | 5.112 | 16.5 | 400 | 1:30 | 1050-14900 | 7:25 | 7:31 | 7:32 |
| 9 | 0.6 | | 0.5 | | | 0.5 | 0.005 | 6.057 | 15.8 | 350 | 1:30 | 1050-14900 | 18:33 | 18:33 | 18:38 |
| 10 | 0.6 | | 0.625 | | | 0.625 | 0.005 | 6.057 | 15.8 | 450 | 1:38 | 1150-16900 | 6:00 | 6:03 | 6:05 |

(1) HEC-Hydroxyethyl cellulose, Natrosol ™ 250 HHBR, commercially available from Ashland Inc.
(2) FLA-L-XxtraDura ™ FLA 3766, commercially available from Ashland Inc.
(3) FLA-P-XxtraDura ™ FLA 3767, commercially available from Ashland Inc.
(4) Defoamer-Drewplus ™ S-4386, commercially available from Ashland Inc.
(5) BHCT is referred to Bottom Hole Circulation Temperature

What is claimed is:

1. A water soluble or dispersible composition comprising a copolymer represented by Formula (I) 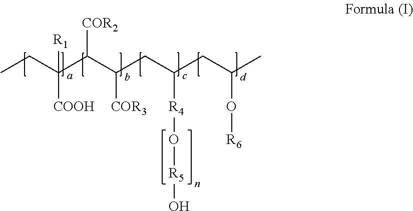
wherein:
R₁ is hydrogen, or straight or branched C₁-C₅ alkyl;
R₂ and R₃ are independently OH or NH₂;
R₄ is C═O, or independently straight or branched C₁-C₅ alkyl;
R₅ is independently straight or branched C₁-C₅ alkyl;
R₆ is hydrogen or COR₇, wherein R₇ is straight or branched C₁-C₅ alkyl; and
n is an integer from 1 to 100.

2. A water soluble or dispersible composition comprising a copolymer represented by Formula (II): 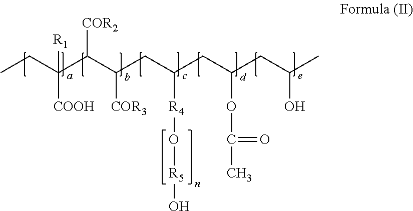
wherein:
R₁ is hydrogen, or straight or branched C₁-C₅ alkyl;
R₂ and R₃ are independently OH or NH₂;
R₄ is C═O or independently straight or branched C₁-C₅ alkyl;
R₅ is independently straight or branched C₁-C₅ alkyl; and
n is an integer from 1 to 100.

3. The composition of claim 1, wherein the composition has a weight average molecular weight of from about 1,000 to about 1,000,000 Daltons.

4. The composition of claim 2, wherein the composition has a weight average molecular weight of from about 1,000 to about 1,000,000 Daltons.

5. The composition of claim 1, wherein the composition comprises a copolymer polymerizing from an alpha, beta ethylenically unsaturated carboxylic acid, an unsaturated dicarboxylic acid, hydroxypolyethoxyl allyl ether, and vinyl acetate.

6. The composition of claim 2, wherein the composition comprises a copolymer polymerizing from an alpha, beta ethylenically unsaturated carboxylic acid, an unsaturated dicarboxylic acid, hydroxypolyethoxyl allyl ether, vinyl acetate, and vinyl alcohol.

7. The composition of claim 5, wherein the alpha, beta ethylenically unsaturated carboxylic acid is acrylic acid or alkylacrylic acid.

8. The composition of claim 6, wherein the alpha, beta ethylenically unsaturated carboxylic acid is acrylic acid or alkylacrylic acid.

9. The composition of claim 5, wherein the unsaturated dicarboxylic acid is maleic acid or anhydride.

10. The composition of claim 6, wherein the unsaturated dicarboxylic acid is maleic acid or anhydride.

11. The composition of claim 7, wherein the alkylacrylic acid is methacrylic acid.

12. The composition of claim 8, wherein the alkylacrylic acid is methacrylic acid.
